(19) United States
(12) Patent Application Publication
(10) Pub. No.: US 2026/0321162 A1
(43) Pub. Date: Oct. 15, 2026

(54) PLAN AHEAD WEEK BOARD TOY

(71) Applicant: Lovevery, Inc., Boise, ID (US)

(72) Inventor: Mackenzie Gail Roan, Golden, CO (US)

(21) Appl. No.: 19/481,097

(22) PCT Filed: Dec. 11, 2023
(86) PCT No.: PCT/US2023/083401

§ 371 Date: Nov. 3, 2025

Related U.S. Application Data
(60) Provisional application No. 63/464,017, filed on May 4, 2023.

(51) Int. Cl. G09D 3/06; G09B 1/08

(52) U.S. Cl. CPC G09D 3/06; G09B 1/08

(57) ABSTRACT

A time management tool (100) for children includes a board (102) having a height, a width, and a front surface (119); one or more pivotable, rigid flaps (104) hingedly secured to the front surface (119), each flap (104) labeled in association with a different day of the week; one or more repositionable activity badges (108) configured to be positioned on a magnetic surface (105) of the one or more flaps (104); and a hinge mechanism (118) pivotably securing the one or more flaps (104) to the front surface (119) about a pivot axis (176). The hinge mechanism (118) includes a pair of deflectable tabs (136) in contact with a rib (128) of the one or more flaps (104). The rib (128) is configured to ride over and deflect the pair of deflectable tabs (136) as the one or more flaps (104) is pivoted about the pivot axis (176).

### TECHNICAL FIELD

This invention relates to toys and more particularly to preschooler toys.

### BACKGROUND

Children at the preschooler stage can benefit from playing with visual calendar and planner toys to help with the learning of daily planning of activities. Such visual calendar and planner toys can be designed to facilitate the creation of routines with discrete daily activities while building responsibility and discipline in children. Improvements in the design, configuration, and safety of such toys and their components are continually sought.

### SUMMARY

In general, this disclosure relates to time management tools for children that include one or more pivotable, rigid flaps and repositionable activity badges.

In one aspect, this disclosure relates to a time management tool for children, the time management tool including: a board having a height, a width, and a front surface; one or more pivotable, rigid flaps hingedly secured to the front surface, each flap labeled in association with a different day of the week; one or more repositionable activity badges configured to be positioned on a magnetic surface of the one or more flaps; and a hinge mechanism pivotably securing the one or more flaps to the front surface about a pivot axis, the hinge mechanism including a pair of deflectable tabs in contact with a rib of the one or more flaps, wherein the rib is configured to ride over and deflect the pair of deflectable tabs as the one or more flaps is pivoted about the pivot axis.

In some embodiments, the pair of deflectable tabs is secured to an elongated recess defined by the front surface.

In some embodiments, the rib of the one or more flaps is received by the elongated recess

In some embodiments, wherein the pair of deflectable tabs has a pair of opposing beveled sides connected by a flat side.

In some embodiments, the flat side of the pair of deflectable tabs contacts a curved surface of the rib.

In some embodiments, the hinge mechanism further includes an upper projection and a lower projection extending outwardly from the elongated recess, the upper and lower projections including a pin.

In some embodiments, the hinge mechanism further includes a hole defined by an upper portion and a lower portion of the rib, the pin configured to be rotatably received by the hole.

In some embodiments, the one or more flaps are configured to move between an open position and a closed position as the one or more flaps are pivoted about the pivot axis.

In some embodiments, in the open position, the magnetic surface of the one or more flaps is exposed, and wherein in the closed position, the magnetic surface of the one or more flaps faces the front surface of the board and is not visible.

In some embodiments, the pivot axis is parallel to a height of the board.

In some embodiments, the front surface of the board includes one or more labels indicating a day of the week and a time of day.

In some embodiments, the one or more flaps are pivotably secured to the front surface such that a height of the one or more flaps is parallel to the height of the board.

In some embodiments, the front surface is a magnetic surface.

In some embodiments, the repositionable activity badges are magnetic activity badges configured to be magnetically coupleable with the magnetic surface.

In some embodiments, the time management tool further includes a pair of feet configured to be removably coupled with the board.

In some embodiments, the pair of feet includes a base transverse to the height of the board, a planar wall extending upwardly from the base, and a curved wall spaced apart proximally from the planar wall by a slot.

In some embodiments, the one or more activity badges include an indicator indicating an activity.

In some embodiments, the slot is configured to receive and support a lower edge of the board.

In some embodiments, the pair of feet further includes a circular projection extending outwardly from the planar wall, the circular projection configured to be removably coupled with a circular recess defined by a rear surface of the board.

In some embodiments, the time management tool further includes a plate fixed to the rear surface of the board, the plate defining one or more blind holes.

Embodiments may provide one or more of the following advantages.

Various embodiments of the present disclosure relate to a time management tool that includes a board and seven rigid flaps hingedly secured to the board. Each of the seven rigid flaps is labeled with a different day of the week which allows the user (e.g., a preschooler) to visually identify each day of the week. The board further includes additional labels on its front surface to indicate a time of day (e.g., morning, afternoon, and night) and the day of the week. These additional labels are adjacent each flap and arranged such that each flap has a “day of the week” label and three “time of day” labels. Such arrangement of these labels may facilitate visually identifying distinct periods of time and days and may help develop planning skills in preschoolers.

Additionally, the time management tool includes repositionable activity badges that each include a label representing a unique activity suitable for a child to plan for and perform (e.g., playing, bike riding, eating ice cream, reading, etc.). These activity badges are magnetic and are configured to reversibly and magnetically couple to a magnetic surface of each flap. The user (e.g., a preschooler) can easily position and reposition each activity badge on each flap corresponding to each day of the week and within a portion on each flap (e.g., on an upper, middle, or lower portion of the magnetic surface) corresponding to each of the three different times of the day. Thus, the repositionability of the activity badges may enable the user to learn to plan several different activities ahead of time and create a routine or a schedule while being able to visualize such routine and/or schedule.

Additionally, each of the seven flaps has a specific color that is distinct and corresponds to a specific day of the week. For example, the seven flaps are of specific colors that correspond to the “Waldorf colors” for the days of the week. Thus, in some embodiments, the individually colored flaps of the board may help create a rhythm and a weekly routine that may be beneficial for children (e.g., preschoolers). In some embodiments, the time management tool of the disclosure includes flaps that are of a distinct color, each of which correspond to a specific day of the week, which may make the passage of time for a child more visual and may facilitate understanding of the abstract concept of time for the child (e.g., a preschooler).

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a time management tool including a board, one or more flaps, and activity badges.

FIG. 2 is a partial enlarged, perspective view of the time management tool of FIG. 1.

FIG. 3 is a partial cross-sectional view of the time management tool taken along the line A-A of FIG. 2.

FIG. 4 is a partial perspective view of the time management tool of FIG. 1.

FIG. 5A is a rear perspective view of the time management tool of FIG. 1.

FIG. 5B is a partial exploded rear perspective view of the time management tool of FIG. 1.

Like reference symbols in the various drawings indicate like elements.

### DETAILED DESCRIPTION

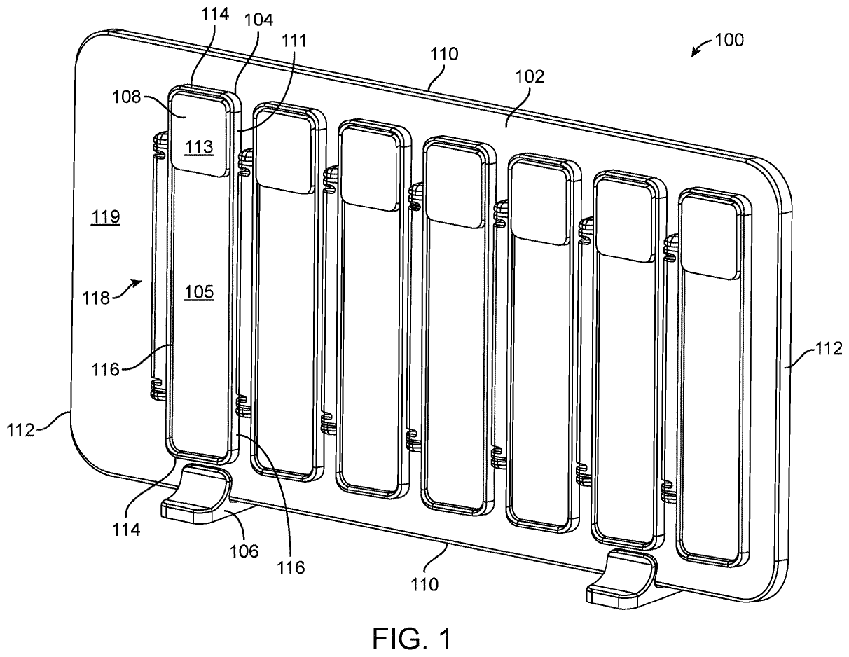

FIG. 1 illustrates a time management tool 100 that can be used by a preschooler (e.g., a child between three and five years of age) for play and/or educational purposes. The time management tool 100 includes a board 102, flaps 104, a pair of feet 106, and one or more activity badges 108. The board 102 is substantially rectangular in shape and has a height, a width, and a thickness. The board 102 has a pair of opposing first sides 110, which correspond to its width, and a pair of opposing second sides, 112, which correspond to its height. The board 102 has a front surface 119 onto which the flaps 104 are hingedly secured. Example materials from which the board 102 may be made include wood (e.g., birch plywood).

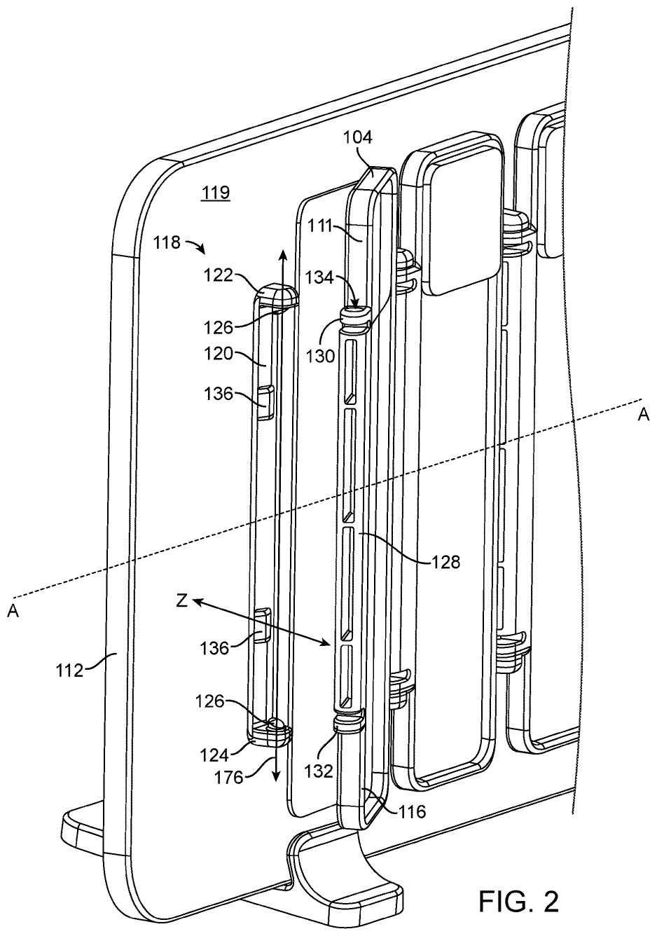

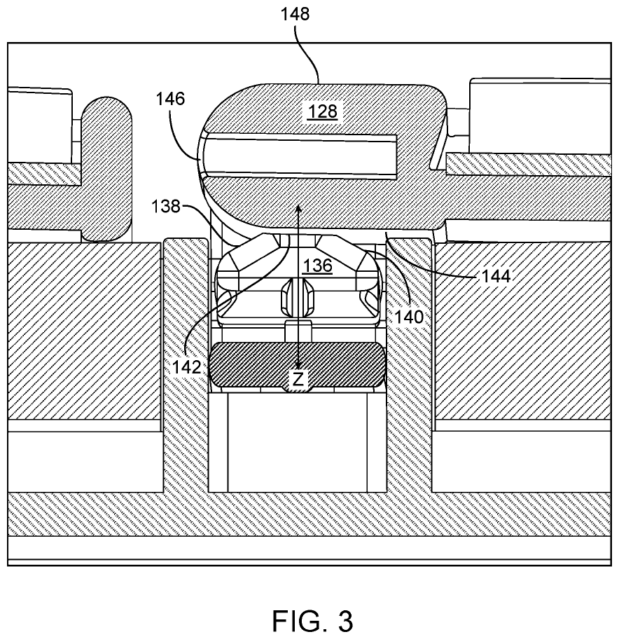

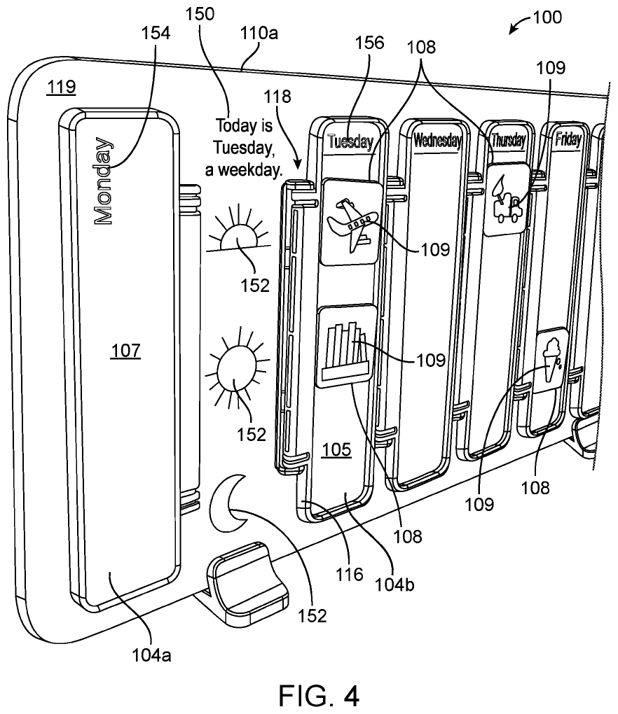

The time management tool 100 includes seven flaps 104. The flaps 104 are pivotable, rigid flaps, and each flap 104 is labeled in association with a different day of the week. Each flap 104 is substantially rectangular in shape and has a length, a width, and a thickness. The flaps 104 have a pair of opposing first sides 114, which correspond to their width and a pair of opposing second sides 116, which correspond to their length. The flaps are disposed on the front surface 119 such that a height (e.g., a second side 116) of each flap 104 is parallel to the height (e.g., a second side 112) of the board 102. The seven flaps 104 are arranged next to each other along the width (e.g., a first side 110) of the board 102. Each flap 104 has a front surface 105 and a rear surface 107 (shown in FIG. 4). The front surface 105 is a magnetic surface that is recessed. As further described in detail below with respect to FIGS. 2 and 3, the flaps 104 are pivotably secured to the front surface 119 of the board 102 via a hinge mechanism 118. The flaps 104 are configured to move between an open position and a closed position as the flaps 104 are pivoted about the hinge mechanism 118. In the open position, the magnetic front surface 105 of the flaps is exposed. For example, FIG. 1 shows all seven flaps 104 in the open position. In the closed position, the magnetic front surface 105 of the flaps 104 faces the front surface 119 of the board 102 and is not visible to the user. For example, FIG. 4 shows a first flap 104a in the closed position and the remaining flaps (e.g., second flap 104b) in the open position. The flaps 104 are arranged such that they do not overlap with each other (e.g., neither in the open nor in the closed position). Example materials from which the flaps 104 may be made include a rigid material (e.g., a rigid plastic).

The time management tool 100 includes one or more activity badges 108, which are magnetic and repositionable tiles. That is, the activity badges 108 are configured to be positioned and repositioned on the front surface 105 of the one or more flaps 104 as desired. The activity badges 108 are configured to magnetically and reversibly couple with the magnetic front surface 105. The activity badges 108 have a thickness that is about equal to a depth of the recessed front surface 105 such that, when magnetically coupled with the front surface 105, a front surface 113 of the activity badges 108 is substantially even with the frame 111 of the flaps 104. Furthermore, also when magnetically coupled with the front surface 105 of the flaps 104, a front surface 113 of the activity badges 108 is configured to be substantially flush with the front surface 119 of the board 102 when a user pivotally moves the flap 104 such that the frame 111 of the flaps 104 contacts the front surface 119 of the board 102, and the front surface 105 of the flaps 104 faces the front surface 119 of the board 102.

The activity badges 108 include an indicator 109 (shown in FIG. 4), which indicates an activity to be performed and/or planned. The indicator 109 is a graphic, an image, or an illustration representative of the activity to be performed and/or planned. As discussed above, the activities the activity badges 108 represent include activities suitable for children (e.g., preschoolers). Non-limiting examples of the images that the indicator 109 can feature include an image of a plane, books, a backpack, a refuse collection vehicle, an ice cream cone, a bicycle, and a doctor, which the user (e.g., a preschooler) may interpret as traveling, reading, going to school, watching a refuse collection vehicle pick up a refuse container, eating a treat or a dessert (e.g., ice cream), going for a bike ride, and going to a doctor's appointment, respectively. In some embodiments, the indicator 109 can be text describing the activity to be performed and/or planned.

Referring to FIGS. 2 and 3, the hinge mechanisms 118 pivotably secure each flap 104 to the front surface 119 of the board 102 about a pivot axis 176, which is parallel to a height (e.g., a second side 112) of the board 102. Each of the seven hinge mechanisms 118 include an upper projection 122 and a lower projection 124, which extend outwardly from an elongated recess 120 defined by the front surface 119 of the board 102. The elongated recess 120 extends longitudinally along the pivot axis 176. Each of the upper and lower projections 122, 124 include a pin 126. The pair of pins 126 oppose each other such that the first pin 126 extends downwardly from a surface of the upper projection 122, and the second pin 126 extends upwardly from a surface of the lower projection 124. Each flap 104 includes a rib 128 that is integrally formed with and extends laterally from a second side 116 of the frame 111 of the flap 104. The rib 128 is configured to be received by the elongated recess 120. The rib 128 includes an upper portion 130 and a lower portion 132, each of which defines a hole 134. Each pin 126 is rotatably received by the hole 134 to enable rotation or pivoting of the flap 104 about the pivot axis 176.

The hinge mechanism 118 further includes a pair of deflectable tabs 136 that contact the rib 128. The pair of deflectable tabs 136 is secured (e.g., fixedly secured) to the elongated recess 120 and longitudinally spaced apart from each other. The deflectable tabs 136 are made of a flexible and/or resilient material. As the flap 104 is pivoted about the pivot axis 176, the rib 128 is configured to ride over and distally deflect the pair of deflectable tabs 136 along the Z-axis.

Referring specifically to FIG. 3, the deflectable tab 136 has a substantially trapezoidal cross-section. The deflectable tab has a first beveled side 138 and a second beveled side 140 connected by a flat side 142. As shown in FIG. 3, the first planar surface 144 of the rib 128 contacts the flat side 142 of the deflectable tab 136 when the flaps 104 have their front surface 105 exposed. As the flap 104 is pivotally rotated, the first planar surface 144 stops contacting the flat side 142, and the curved surface 146 of the rib 128 begins contacting and deflecting the flat side 142 of the deflectable tab 136. In other words, the deflectable tab 136 begins transitioning from an original, undeflected state to a deflected state. When the flap 104 is aligned with the Z-axis, the center of the curved surface 146 of the rib 128 makes full contact with the flat side 142 and maximally deflects the deflectable tab 136 in a distal direction (shown as a downwardly direction in FIG. 3) along the Z-axis. As the flap 104 continues to be pivotally rotated, the curved surface 146 stops contacting the flat side 142, and the second planar surface 148 of the rib 128 begins contacting the flat side 142 of the deflectable tab 136. As the second planar surface 148 of the rib 128 contacts the flat side 142, the deflectable tab 136 begins to return to the original, undeflected state. As the deflectable tab 136 returns to the original, undeflected state, it acts as a spring and pushes against the rib 128 urging the flap 104 to move against and contact the front surface 119 of the board 102 to transition into either an open position or a closed position. Once the flap 104 is fully, pivotally rotated, the second planar surface 148 of the rib 128 fully contacts the flat side 142, and the deflectable tab 136 returns to the original, undeflected state, thereby transitioning the flap 104 into an open or closed position. When the flap 104 contacts the front surface 119 of the board 102, an audible feedback is generated (e.g., in the form of a single click).

Referring to FIG. 4, the front surface 119 of the board 102 includes multiple labels indicating the day of the week and the time of day. For example, the front surface 119 includes a first label 150 indicating the day of the week, and three second labels 152 indicating three different times of the day. The first label 150 is text that is horizontally aligned adjacent an upper, first side of the board 110a. The second labels 152 are images illustrating the three different times of the day (e.g., morning, noon or afternoon, and evening or night). The second labels 152 include images of a rising sun, a full sun, and a moon to pictorially represent the three different times of the day. The second labels 152 are longitudinally spaced apart from each other and are longitudinally arranged below the first label 150. As described above, the flaps 104 are configured to move between an open position and a closed position as they are pivoted about the pivot axis 176. In the open position, the magnetic front surface 105 of the flaps and any activity badges 108 (including their indicator 109) positioned on and magnetically coupled to the front surface 105 are exposed and visible to the user. In the closed position, the magnetic front surface 105 of the flaps 104 and any activity badges 108 (including their indicator 109) positioned on and magnetically coupled to the front surface 105 face the front surface 119 of the board 102 and are not visible to the user. For example, FIG. 4 shows a first flap 104a in the closed position and the remaining flaps (e.g., second flap 104b) in the open position.

The first and second labels 150, 152 are exposed and visible to the user when their corresponding, adjacent flap 104 is in the open position. The first and second labels 150, 152 are configured to be aligned with one or more activity badges 108 when their corresponding, adjacent flap 104 is in the open position. For example, the first and second labels 150, 152 are disposed adjacent a second side 116 of each flap 104. Specifically, each set of the first and second labels 150, 152 is disposed adjacent a hinge mechanism 118 of the corresponding, adjacent flap 104. When a flap 104 is in the open position, such arrangement of the first and second labels 150, 152 enables the user to align one or more activity badges 108 to a second label 152. For example, the user can arrange the activity badges 108 parallel to a second label 152, which indicates the activity represented by the activity badge 108 is to be performed at the time of day indicated by the second label 152 that the activity badge 108 is aligned with or parallel to.

The front surface 119 of the board 102 further includes third label 154 on the rear surface 107 and a fourth label 156 on the front surface 105. For example, the second and third labels 154, 156 include text indicating each day of the week. The third label 154 is vertically aligned and positioned on an upper portion of the rear surface 107. The fourth label 156 is horizontally aligned and positioned on an upper portion of the front surface 105, such that it aligns with the first label 150, as shown in FIG. 4.

Additionally, each of the seven flaps 104 is of or has a specific color that is distinct and corresponds to a specific day of the week. For example, the seven flaps 104 can be purple, red, yellow, orange, green, blue, and white, which correspond to Monday, Tuesday, Wednesday, Thursday, Friday, Saturday, and Sunday. These specific colors of the flaps 104 can be the same as the “Waldorf colors” for the days of the week, which is a well-known tool used to identify the days of the week based on the Waldorf pedagogy. In some embodiments, each of the seven flaps 104 is of or has a specific color that the user can readily identify with a day of the week. Other embodiments with flaps 104 having one or more colors that are different than the “Waldorf colors,” yet still used to indicate the specific days of the week to a user, are contemplated within the scope of this disclosure.

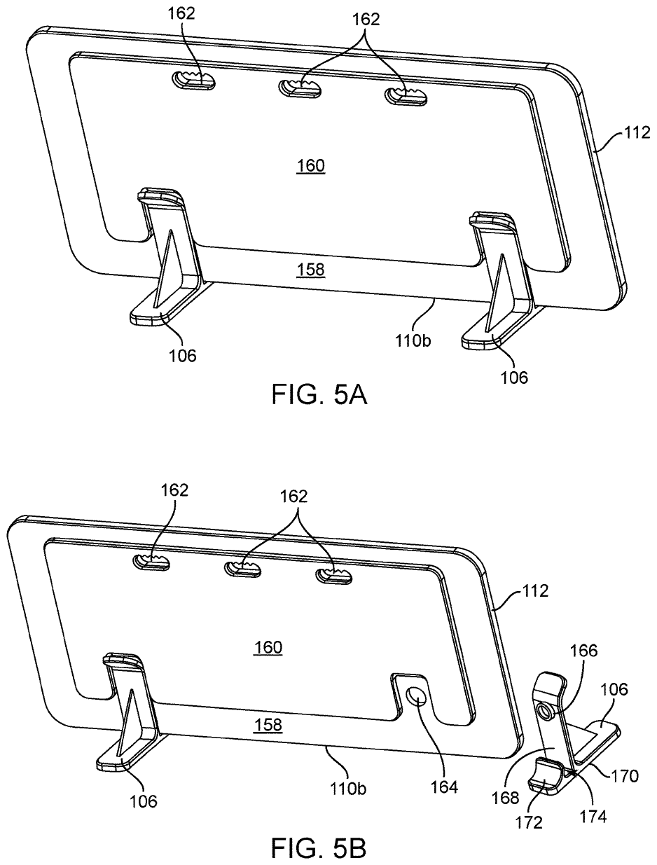

Referring to FIGS. 5A and 5B, the time management tool 100 includes a pair of feet 106 configured to support and be removably coupled with the board 102. The pair of feet 106 each include a base 170 transverse to the height (e.g., a second side 112) of the board 102. The pair of feet 106 includes a planar wall 168 extending upwardly from the base 170 and a curved wall 172 spaced apart proximally from the planar wall 168 by a slot 174. The slot 174 is configured to receive and support a lower first side 110b of the board 102. The pair of feet 106 further includes a circular projection 166 extending outwardly from the planar wall 168. The circular projection 166 is configured to be removably coupled with a circular recess 164 defined by a rear surface 158 of the board 102. The board 102 further includes a plate 160 fixed to the rear surface 158 of the board. The plate 160 defines three blind holes 162 that are configured to receive a fastener, projection, peg, etc. that may be used to hang the board 102 on a surface. For example, if the user wishes to hang the board 102 on a wall, the user can remove the pair of feet 106 and hang the board 102 using one or more of the three blind holes 162.

The use of terminology such as “front” and “rear” throughout the specification and claims is for describing the relative positions of various components of the time management tool and other elements described herein. Similarly, the use of any horizontal or vertical terms to describe elements is for describing relative orientations of the various components of the time management tool and other elements described herein. Unless otherwise stated explicitly, the use of such terminology does not imply a particular position or orientation of the time management tool or any other components relative to the direction of the Earth's gravitational force, or the Earth's ground surface, or other particular position or orientation that the time management tool or other elements may be placed in during manufacturing, use, or play.

The use of the term “about,” as used herein, refers to an amount that is near the stated amount by about 10%, 5%, or 1%, including increments therein. For example, “about” can mean a range including the particular value and ranging from 10% below that particular value and spanning to 10% above that particular value.

While a number of examples have been described for illustration purposes, the foregoing description is not intended to limit the scope of the invention, which is defined by the scope of the appended claims. There are and will be other examples and modifications within the scope of the following claims.

1.-20. (canceled)

21. A time management tool for children, the time management tool comprising:
aboard having a height, a width, and a front surface;
one or more pivotable, rigid flaps hingedly secured to the front surface, each flap labeled in association with a different day of the week;
one or more repositionable activity badges configured to be positioned on a magnetic surface of the one or more flaps; and
a hinge mechanism pivotably securing the one or more flaps to the front surface about a pivot axis, the hinge mechanism comprising a pair of deflectable tabs in contact with a rib of the one or more flaps,
wherein the rib is configured to ride over and deflect the pair of deflectable tabs as the one or more flaps is pivoted about the pivot axis, and
wherein the pair of deflectable tabs is secured to an elongated recess defined by the front surface of the board.

22. The time management tool of claim 21, wherein the rib of the one or more flaps is received by the elongated recess.

23. The time management tool of claim 21, wherein the pair of deflectable tabs has a pair of opposing beveled sides connected by a flat side.

24. The time management tool of claim 23, wherein the flat side of the pair of deflectable tabs contacts a curved surface of the rib.

25. The time management tool of claim 23, wherein the hinge mechanism further comprises an upper projection and a lower projection extending outwardly from the elongated recess, the upper and lower projections including a pin.

26. The time management tool of claim 25, wherein the hinge mechanism further comprises a hole defined by an upper portion and a lower portion of the rib, the pin configured to be rotatably received by the hole.

27. The time management tool of claim 21, wherein the one or more flaps are configured to move between an open position and a closed position as the one or more flaps are pivoted about the pivot axis.

28. The time management tool of claim 27, wherein in the open position, the magnetic surface of the one or more flaps is exposed, and wherein in the closed position, the magnetic surface of the one or more flaps faces the front surface of the board and is not visible.

29. The time management tool of claim 21, wherein the pivot axis is parallel to a height of the board.

30. The time management tool of claim 21, wherein the front surface of the board includes one or more labels indicating a day of the week and a time of day.

31. The time management tool of claim 21, wherein the one or more flaps are pivotably secured to the front surface of the board such that a height of the one or more flaps is parallel to the height of the board.

32. The time management tool of claim 21, wherein a front surface of the one or more flaps is a magnetic surface.

33. The time management tool of claim 32, wherein the repositionable activity badges are magnetic activity badges configured to be magnetically coupleable with the magnetic surface.

34. The time management tool of claim 21, further comprising a pair of feet configured to be removably coupled with the board.

35. The time management tool of claim 34, wherein the pair of feet includes a base transverse to the height of the board, a planar wall extending upwardly from the base, and a curved wall spaced apart proximally from the planar wall by a slot.

36. The time management tool of claim 21, wherein the one or more activity badges include an indicator indicating an activity.

37. The time management tool of claim 35, wherein the slot is configured to receive and support a lower edge of the board.

38. The time management tool of claim 35, wherein the pair of feet further includes a circular projection extending outwardly from the planar wall, the circular projection configured to be removably coupled with a circular recess defined by a rear surface of the board.

39. The time management tool of claim 38, further comprising a plate fixed to the rear surface of the board, the plate defining one or more blind holes.
